(19) United States
(12) Patent Application Publication
(10) Pub. No.: US 2013/0014503 A1
(43) Pub. Date: Jan. 17, 2013

(54) HOUSING ASSEMBLY FOR FORCED AIR INDUCTION SYSTEM

(71) Applicants: Edward R. Romblom, DeWitt, MI (US); Ronald M. Tkac, Brighton, MI (US)

(72) Inventors: Edward R. Romblom, DeWitt, MI (US); Ronald M. Tkac, Brighton, MI (US)

(73) Assignee: GM GLOBAL TECHNOLOGY OPERATIONS LLC, Detroit, MI (US)

(21) Appl. No.: 13/183,969

(22) Filed: Jul. 15, 2011

(51) Int. Cl. F02B 33/44; F17D 1/00

(52) U.S. Cl. 60/605.1; 137/1

(57) ABSTRACT

In one exemplary embodiment of the present invention, a housing assembly for a forced induction system of an internal combustion engine is provided. The housing includes a turbine housing that further includes a turbine inlet passage in fluid communication with a turbine volute configured to house a turbine wheel. The housing assembly also includes a turbine outlet passage integrated in the turbine housing, the turbine outlet passage in fluid communication with the turbine volute, the turbine outlet passage configured to direct the exhaust gas flow to a catalytic converter coupled to the turbine outlet passage. Further, the housing assembly includes a compressor housing integrated with a compressor inlet passage in fluid communication with a compressor volute configured to house a compressor wheel coupled to the turbine wheel, the compressor inlet passage including a wall that is shared with the compressor volute.

### FIELD OF THE INVENTION

The subject invention relates to turbochargers, and air induction systems, and, more particularly, to a turbocharger housing assembly having an integrated compressor inlet passage and an integrated turbine outlet passage.

### BACKGROUND

The use of forced-induction, particularly including turbochargers, in modern internal combustion engines, including both gasoline and diesel engines, is frequently employed to increase the engine intake mass airflow and the power output of the engine. It is desirable to have turbocharged engines efficiently use the energy available in the exhaust system in order to improve overall engine efficiency and fuel economy. Conduits directing a supply of air to a compressor in the turbocharger is one of many factors that affect turbocharger efficiency. Specifically, angles at intersections of ducts, passages or conduits in a flow path of a turbocharger affect a flow velocity into the compressor wheel and/or out of a turbine volute.

Further, as engines become more complex, packaging of various turbocharger components can make design of the air flow path, the turbocharger and the engine system challenging. For example, ducts or conduits directing air into the turbocharger may interfere with other engine components, resulting in packaging constraints.

In addition, efficient communication of exhaust gas between the engine, turbocharger and exhaust gas after treatment systems necessitates synergistic design of these systems. For example, as emissions regulations become more stringent and packaging constraints increase, a closely coupled catalytic converter may be mounted directly to the turbocharger exhaust outlet. This may impact the performance of the turbocharger and/or exhaust after treatment systems.

Accordingly, improved design of the turbocharger, the air induction system and the exhaust after treatment systems will improve packaging while reducing complexity and number of components, thereby leading to improved cost, efficiency and performance.

### SUMMARY OF THE INVENTION

In one exemplary embodiment of the invention, a housing assembly for a forced induction system of an internal combustion engine is provided. The housing includes a turbine housing that further includes a turbine inlet passage in fluid communication with a turbine volute that is configured to house a turbine wheel, the turbine inlet passage configured to direct an exhaust gas flow from an exhaust manifold of the internal combustion engine to the turbine wheel. The housing assembly also includes a turbine outlet passage integrated in the turbine housing, the turbine outlet passage in fluid communication with the turbine volute, and configured to direct the exhaust gas flow to a catalytic converter coupled to the turbine outlet passage, wherein the turbine outlet passage includes a cone shaped passage. Further, the housing assembly includes a compressor housing integrated with a compressor inlet passage in fluid communication with a compressor volute that is configured to house a compressor wheel coupled to the turbine wheel, the compressor inlet passage including a wall that is shared with the compressor volute.

In another exemplary embodiment of the invention, a method for forced air induction of an internal combustion engine is provided. The method includes directing an exhaust gas flow from an exhaust manifold via a turbine inlet passage to a turbine volute that is configured to house a turbine wheel and directing the exhaust gas flow from the turbine volute to a turbine outlet passage, wherein the turbine outlet passage comprises a cone shaped substantially asymmetrical passage. The method also includes directing the exhaust gas flow from the turbine outlet passage to a catalytic converter coupled to the turbine outlet passage and directing an air flow into a compressor inlet passage integrated in a compressor housing, wherein the compressor inlet passage includes an offset portion to induce a swirling air flow into a compressor volute.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is an exemplary diagram of an internal combustion engine that includes a turbocharger;

FIG. 2 is a side view of an exemplary turbocharger;

FIG. 3 is a sectional end view of an exemplary compressor portion of the turbocharger of FIG. 2;

FIG. 4. is a sectional side view of an exemplary compressor portion of FIG. 3;

FIG. 5 is a sectional side view of an exemplary turbine portion of the turbocharger of FIG. 3; and

FIG. 6. is a detailed sectional side view of a portion of the exemplary turbine portion FIG. 5.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

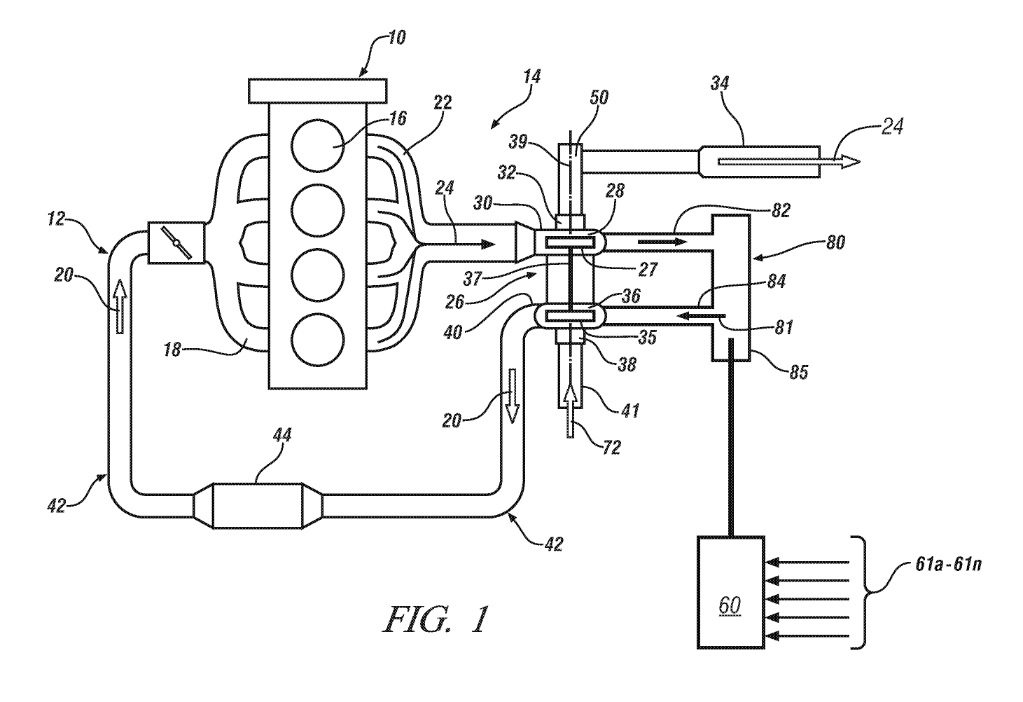

In accordance with an exemplary embodiment of the invention, FIG. 1 illustrates an internal combustion engine 10, in this case an in-line four cylinder engine, including an intake system 12 and an exhaust system 14. The internal combustion engine 10 includes a plurality of cylinders 16 into which a combination of combustion air and fuel are introduced. The combustion air/fuel mixture is combusted in the cylinders 16 resulting in reciprocation of pistons (not shown) therein. The reciprocation of the pistons rotates a crankshaft (not shown) to deliver motive power to a vehicle powertrain (not shown) or to a generator or other stationary recipient of such power (not shown) in the case of a stationary application of the internal combustion engine 10.

The internal combustion engine 10 includes an intake manifold 18 in fluid communication with the cylinders 16; where the intake manifold 18 receives a compressed intake charge 20 from the intake system 12 and delivers the charge to the plurality of cylinders 16. The exhaust system 14 includes an exhaust manifold 22, also in fluid communication with the cylinders 16, which is configured to remove combusted constituents of the combustion air and fuel (i.e. exhaust gas 24) and to deliver it to an exhaust driven turbocharger 26 located in fluid communication therewith. The turbocharger 26 includes an exhaust gas turbine wheel 27 that is housed within a turbine housing 28. The turbine housing 28 includes an inlet 30 and an outlet 32. The outlet 32 is in fluid communication with the remainder of the exhaust system 14 and delivers the exhaust gas 24 to an exhaust gas conduit 34. The exhaust gas conduit 34 may include various exhaust after treatment devices, such as a catalytic converter 50. As depicted, the catalytic converter 50 is close coupled to the outlet 32 of the turbocharger 26 and is configured to treat various regulated constituents of the exhaust gas 24 prior to its release to the atmosphere. In embodiments, the turbocharger 26 may be any suitable forced air induction apparatus, such as a twin scroll turbocharger or a twin turbocharger.

The turbocharger 26 also includes an intake charge compressor wheel 35 that is housed within a compressor housing 36. The compressor wheel 35 is coupled by a shaft 37 to the turbine wheel 27, wherein the compressor wheel 35, the shaft 37, and the turbine wheel 27 rotate about an axis 39. The compressor housing 36 includes an inlet 38 and an outlet 40. The inlet 38 is a passage that is in fluid communication with an air supply conduit 41, which delivers fresh air 72 to the compressor housing 36. The outlet 40 is in fluid communication with the intake system 12 and delivers a compressed intake charge 20 through an intake charge conduit 42 to the intake manifold 18. The intake charge 20 is distributed by the intake manifold 18 to the cylinders 16 of the internal combustion engine 10 for mixing with fuel and for combustion therein. In an exemplary embodiment, disposed inline between the compressor housing outlet 40 and the intake manifold 18 is a compressed intake charge cooler 44. The compressed intake charge cooler 44 receives the heated (due to compression) compressed intake charge 20 from the intake charge conduit 42 and, following cooling of the compressed intake charge 20 therein, delivers it to the intake manifold 18 through a subsequent portion of the intake charge conduit 42.

Located in fluid communication with the exhaust system 14, and in the exemplary embodiment shown in FIG.1, is an exhaust gas recirculation (“EGR”) system 80. The EGR system 80 includes EGR supply conduit 82, EGR inlet conduit 84, and EGR valve 85. In one embodiment, the EGR supply conduit 82 is in fluid communication with, and coupled to, the turbine housing 28. In addition, the EGR inlet conduit 84 is in fluid communication with, and coupled to, compressor housing 36. The EGR supply conduit 82 is configured to divert a portion of the exhaust gas 24 from the turbine housing 28 and to recirculate it to the intake system 12 through the compressor housing 36 of the exhaust driven turbocharger 26. As depicted, the EGR valve 85 is in signal communication with a control module such as an engine controller 60. The EGR valve 85 adjusts the volumetric quantity of exhaust gas 24 that is diverted, as recirculated exhaust gas 81 (“EGR”), to the intake system 12, based on the particular engine operating conditions at any given time. The engine controller 60 collects information regarding the operation of the internal combustion engine 10 from sensors 61a-61n, such as temperature (intake system, exhaust system, engine coolant, ambient, etc.), pressure, exhaust system conditions, driver demand and, as a result, may adjust many engine conditions and operations, including the flow of exhaust gas 24 through the EGR valve 85 to be mixed with fresh air 72, as EGR 81, to form the compressed intake charge 20. As a result, the compressed intake charge 20 may comprise a continuously variable combination of fresh air 72 and EGR 81, depending on the commanded quantity of EGR by the controller 60. As used herein, the term controller refers to an application specific integrated circuit (ASIC), an electronic circuit, a processor (shared, dedicated or group) and memory that executes one or more software or firmware programs, a combinational logic circuit, and/or other suitable components that provide the described functionality.

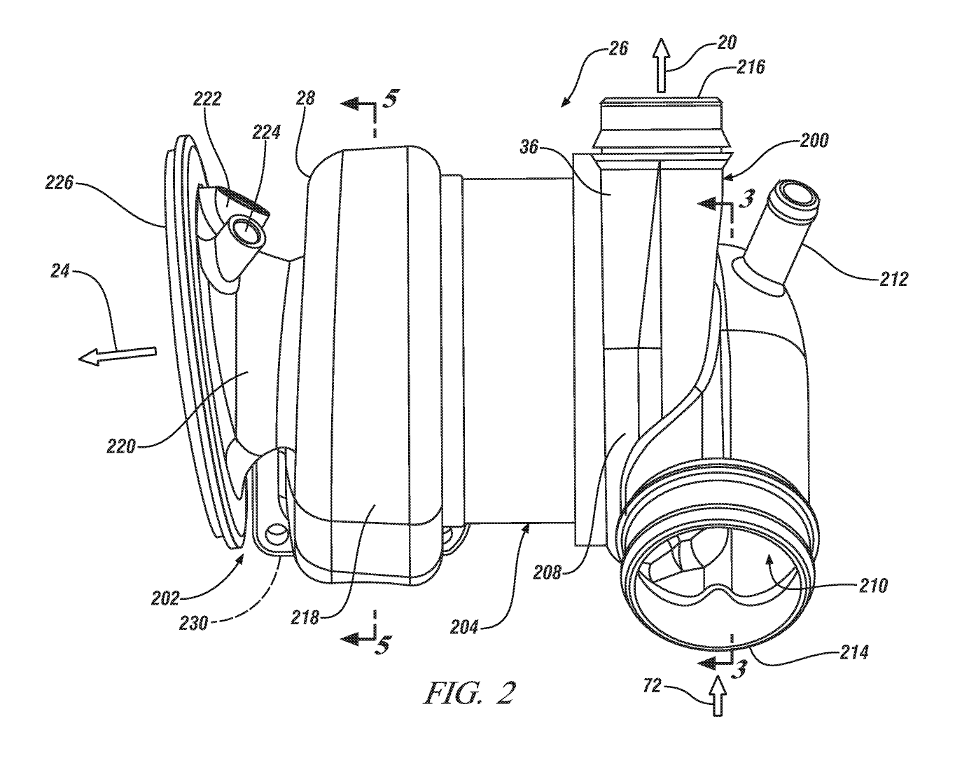

Still referring to the exemplary embodiment of FIG. 1, the compressor inlet 38 is integrated into compressor housing 36. The fresh air 72 flows through air supply conduit 41 toward a volute in the compressor housing 36, wherein the compressor wheel 35 compresses the air. By integrating the compressor inlet 38 and the compressor housing 36 as a single component, the flow path of fresh air 72 is controlled to provide improved and increased air flow into the compressor housing 36. An exemplary compressor inlet 38 provides a tangential component to the flow of fresh air 72, thereby causing a swirling effect as the air flows into the compressor housing 36. Further, the compressor inlet 38 also includes an offset portion to induce swirling of the fresh air 72. The swirling fresh air 72 is configured to swirl in the same rotational direction of compressor wheel 35, thereby improving air intake and efficiency of the turbocharger 26. Further, integration of the compressor inlet 38 and compressor housing 36 reduces the number of individual components in the turbocharger 26, thereby reducing cost and simplifying manufacture of the turbocharger 26. Exemplary embodiments of the turbocharger 26 as well as various arrangements thereof are described in detail below with reference to FIGS. 2-4.

FIG. 2 is a side view of an exemplary turbocharger 26 which includes a compressor portion 200, a turbine portion 202 and a shaft housing 204. The compressor portion 200 includes the compressor housing 36, a compressor volute 208 and a compressor inlet 210. The compressor volute 208 houses compressor wheel 35 (FIG. 1) and receives fresh air 72 via the compressor inlet 210 (also referred to as “compressor inlet passage” or as “compressor inlet duct”). A PCV valve housing 212 may be integrated into the compressor inlet 210 and receives a PCV valve. The fresh air 72 is directed through an inlet opening 214, wherein the compressor volute 208 receives the fresh air 72. The compressor wheel 35 compresses the fresh air 72 to form the compressed intake charge 20, which is directed to the intake manifold 18 (FIG. 1) by a compressor housing outlet 216. The turbine portion 202 includes the turbine housing 28, a turbine volute 218, a turbine outlet 220 and optional sensor housings 222 and 224. The turbine outlet 220 (also referred to as “turbine outlet passage” or as “turbine compressor outlet duct”) is integrated into the turbine housing 28 and includes a turbine outlet opening 226 configured to direct exhaust gas 24 to an exhaust treatment system, such as the catalytic converter 50. The exhaust gas 24 is received by a turbine inlet 230 and is directed to the turbine wheel 27 (FIG. 1) within the turbine volute 218. The flow of exhaust 24 through the turbine housing 28, including turbine volute 218, drives rotation of the turbine wheel 27 (FIG. 1) and, accordingly, compressor wheel 35, thus providing the compressed intake charge 20 for the internal combustion engine 10 (FIG. 1). As discussed herein, the combination of the compressor portion 200, the turbine portion 202 and the shaft housing 204 may be referred to as a housing assembly.

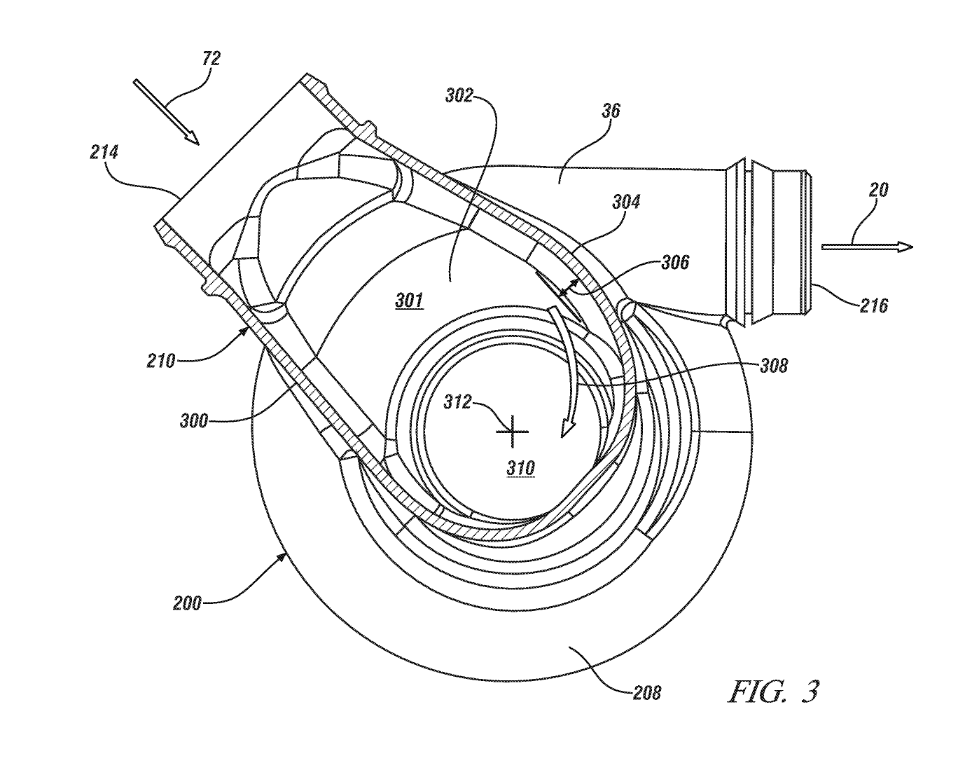

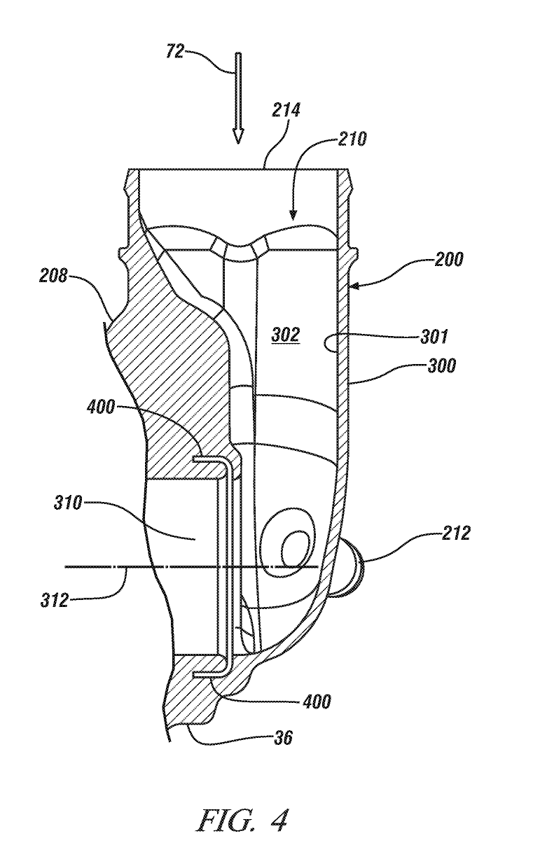

FIG. 3 is a sectional end view of the compressor portion 200 including the compressor inlet 210 integrated into the compressor housing 36. The compressor inlet 210 comprises an inlet wall 300 that forms a passage 301 to receive the fresh air 72 flowing into the compressor inlet 210. The exemplary compressor inlet 210 and compressor housing 36 share at least a portion of a shared wall 302. The shared wall 302 reduces the overall size of the compressor portion 200, such as an axial length of the compressor portion 200. In addition, the compressor inlet 210 comprises an offset or divergent portion 304 which is offset a selected distance 306 to form a swirl or rotational component 308 as the fresh air 72 flows through the compressor inlet 210. The offset portion 304 is offset by the distance 306, thereby forming a non-concentric cavity and flow path around and into a substantially circular volute opening 310. The swirl or rotational component 308 of air flow formed by offset portion 304 swirls about a compressor wheel axis 312 (perpendicular to FIG. 3, also shown in FIG. 4). By integrating the compressor inlet 210 and the compressor housing 36, the overall axial length of the compressor portion 200 is reduced while enabling an improved design and control of the flow path for the fresh air 72 into the compressor volute 208, thereby improving performance of the turbocharger 26 (FIG. 1). The integrated compressor inlet 210 and compressor housing 36 may be formed from a metallic alloy or other suitable durable material, such as a steel alloy cast into a single piece, reducing the number of turbocharger components. The exemplary shared wall 302 shares at least a portion of the wall with the compressor inlet and a second portion of the wall with the inside of the compressor volute 208.

FIG. 4 is a sectional side view of the exemplary compressor portion 200 FIG. 3. As depicted, the fresh air 72 is received by the compressor inlet 210 and is directed into the compressor volute 208 via the opening 310. The fresh air 72 flows through the passage 301 formed by the inlet wall 300, wherein the flow path is configured to improve the performance of the turbocharger 26 by creating the rotational component or air flow swirl 308 (FIG. 3) about the compressor wheel axis 312. In an embodiment, the air flow swirl 308 is in the same direction as the rotation of the compressor wheel 35 (FIG. 1), thereby increasing the volume of air compressed by the compressor wheel 35, resulting in improved performance of the turbocharger 26. The compressor inlet 210 may also include a recirculation duct 400 configured to allow fluid communication and air flow from the compressor volute 208 into the compressor inlet 210. The exemplary recirculation duct 400 may also be integrated into the design of the compressor housing 36, further simplifying the turbocharger 26 assembly. An exemplary compressor portion 200 with the integrated compressor inlet 210 and compressor housing 36 controls the flow path of fresh air 72 to improve turbocharger 26 performance. In one embodiment, compressor efficiency is improved by about 0.5 to about 2.5%. In another embodiment, compressor efficiency is improved by about 1 to about 2%. In yet another embodiment, compressor efficiency is improved by greater than about 1%. Compressor efficiency may be defined as a calculated isentropic compressor temperature out divided by the actual compressor outlet temperature. Actual outlet temperature is typically higher due to frictional losses caused by manipulating the gas through the compressor, such as having to rotate the gas with the compressor wheel.

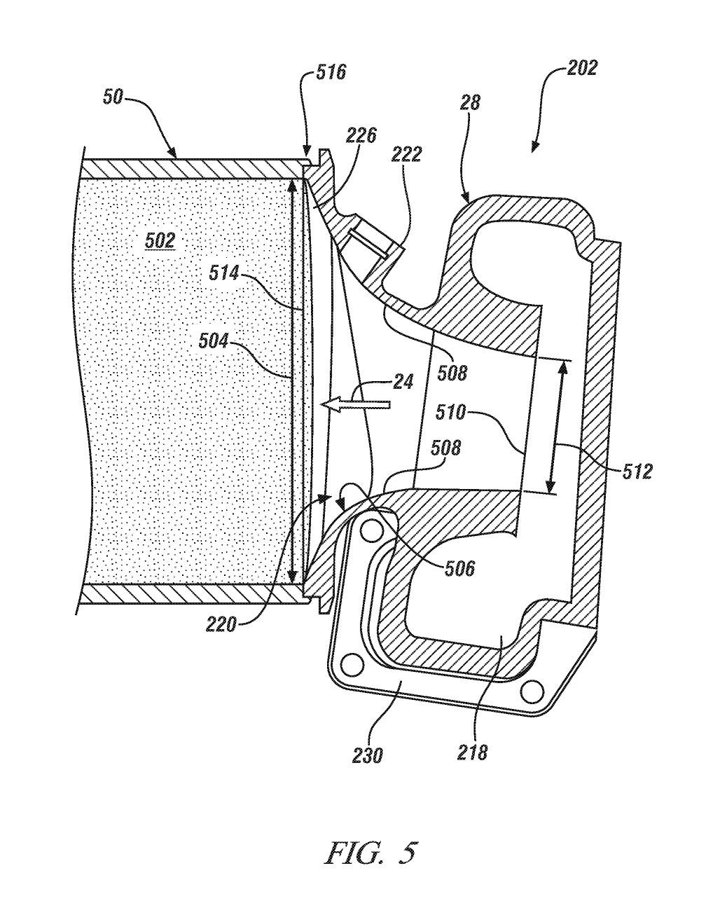

FIG. 5 is a sectional side view of the exemplary turbine portion 202 including the turbine outlet 220 (also referred to as “turbine outlet passage”) integrated into the turbine housing 28. The turbine outlet 220 is closely coupled to catalytic converter 50 which houses a substrate 502 configured to reduce pollutants from the exhaust gas 24. As depicted, a diameter 504 of an opening in the turbine outlet 220 is substantially equal to a diameter of the catalytic converter 50. The exemplary turbine outlet 220 comprises a cone shaped passage 506, wherein the cone shape includes an arced or tapered wall or inner surface 508 that gradually expands in a direction of the exhaust gas 24 flow. Accordingly, a cross section of the inner surface 508 of the cone shaped passage 506 comprises an arc or is arc shaped. Further, the cone shaped passage 506 comprises an outlet 510 from the volute 218 wherein a diameter 512 of the cone shaped passage 306 gradually increases along the arced inner surface 508 in the direction of exhaust 228 flow.

The geometry of the cone shaped passage 506 enables control over the flow of exhaust gas 24, thereby enabling improved distribution of the exhaust gas 24 across the inlet face 514 and through the substrate 502. As exhaust gas 24 is evenly distributed throughout the substrate 502, it improves performance of the exhaust after treatment system. The system improves pollutant reduction as well as flow into and through the substrate 502. The exemplary turbine outlet 220 may be coupled directly to the catalytic converter 50, thereby positioning the substrate 502 proximate the turbine outlet opening 226 and minimizing temperature loss from the exhaust gas 24. Thus, the turbine outlet 220 controls and uniformly distributes the exhaust gas 24 flow in part due to a direct coupling 516 to the catalytic converter 50. In an embodiment, the distribution of exhaust 24 is described by a uniformity index. An exemplary for turbine outlet 220 has a uniformity index greater than about 0.7 and is about 7% higher as compared to other turbine outlet configurations. In another example, a uniformity index is greater than about 0.9 at a selected operating condition for the emission cycle. Exemplary operation conditions include 1200-1600 RPM, such as 1400 RPM, at 4 bar mean effective pressure (load on the piston). Flow uniformity index may be generally described as a calculated value that indicates the relative amount of flow velocity variation on a defined plane in a flow path. An equation used to calculate uniformity index is:

$$UI = 1 - \frac{1}{2} \frac{\int \vert u - \tilde{u} \vert d A}{\tilde{u} \int d A} ; where$$

$$\tilde{u} = \frac{\int u d A}{\int d A} ;$$

A=flow area being analyzed; dA=individual portions of the area where velocity can be measured in each portion; and u=velocity magnitude.

In an embodiment, improved distribution of the exhaust gas 24 into the catalytic converter 50 improves flow from the turbine volute 218. The improved flow from the turbine volute 218 improves flow of exhaust gas 24 through the housing 28 to reduce resistance on the rotating turbine wheel 27 as it is driven by incoming exhaust gas flow. Thus, the exemplary turbocharger 26 and the turbine housing 28 experience improved performance. In addition, the exemplary turbine outlet 220 comprises a substantially asymmetrical geometry, further enhance gas distribution.

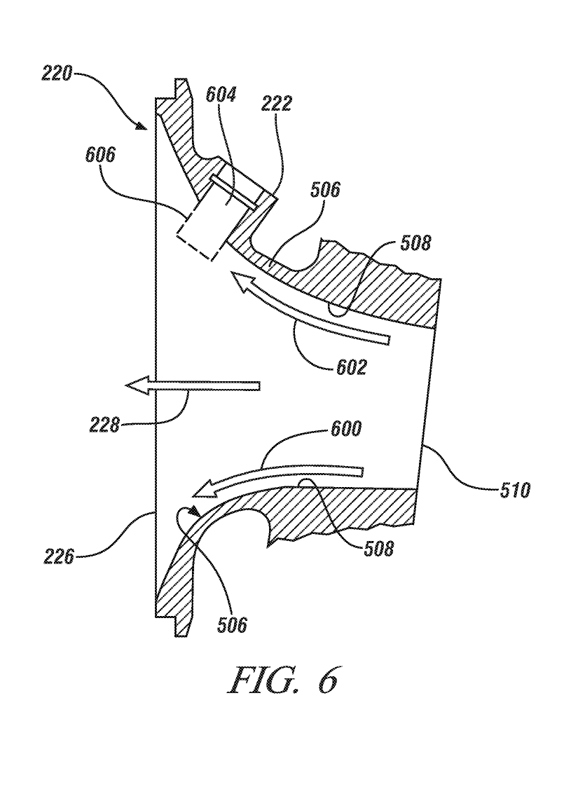

FIG. 6 is a detailed side view of a portion of the exemplary turbine outlet 220 illustrated in FIG. 5. As depicted, the cone shaped passage 506 is configured to direct portions of the exhaust gas flow 24 (600 and 602) outwardly along inner surface 508 to improve distribution of exhaust gas 24 at the turbine outlet opening 226. The exemplary turbine outlet 220 may comprise a sensor housing 222 configured to receive a sensor 606 in a cavity 604. The sensor 606 is configured to protrude from the cavity 604 as shown in phantom lines in the figure, wherein the protruding sensor is in the path of exhaust flow 602. By placing the sensor in the exhaust flow path 602, the accuracy of the sensor measurement is improved. Exemplary sensors may be configured to determine various exhaust parameters, including, but not limited to, temperature, NOx content, oxygen content or amounts of other constituencies in the exhaust gas. Thus, the disclosed arrangement of turbine outlet 220 and housing 28 improves measurements obtained from the sensor 606.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A housing assembly for a forced induction system of an internal combustion engine, the housing comprising:
a turbine housing comprising a turbine inlet passage in fluid communication with a turbine volute that is configured to house a turbine wheel, the turbine inlet passage configured to direct an exhaust gas flow from an exhaust manifold of the internal combustion engine to the turbine wheel;
a turbine outlet passage integrated in the turbine housing, the turbine outlet passage in fluid communication with the turbine volute, and configured to direct the exhaust gas flow to a catalytic converter coupled to the turbine outlet passage, wherein the turbine outlet passage comprises a cone shaped passage; and
a compressor housing integrated with a compressor inlet passage in fluid communication with a compressor volute that is configured to house a compressor wheel coupled to the turbine wheel, the compressor inlet passage comprising a wall that is shared with the compressor volute.

2. The housing assembly of claim 1, wherein the compressor inlet passage is in fluid communication with an air supply conduit.

3. The housing assembly of claim 1, wherein the compressor inlet passage creates an air flow with a flow component that is substantially tangential with respect to an axis of the compressor wheel.

4. The housing assembly of claim 1, wherein the compressor inlet passage comprises a substantially offset portion with respect to an opening of the compressor volute to induce a swirl of air flow into the compressor volute.

5. The housing assembly of claim 1, wherein the cone shaped passage is configured to distribute the exhaust gas flow across a substrate face of the catalytic converter.

6. The turbine housing of claim 1, wherein the cone shaped passage directs a portion of the exhaust gas flow outwardly along an inner surface of the cone shaped passage.

7. The turbine housing of claim 1, wherein an inner surface of the cone shaped passage comprises a flow area that increases in a direction of the exhaust gas flow.

8. The turbine housing of claim 1, wherein an opening of the turbine outlet is coupled to the catalytic converter via a coupling.

9. The turbine housing of claim 1, wherein the exhaust gas flow in the turbine outlet passage has a flow uniformity value into the catalytic converter of greater than about 0.9 at a selected operating condition.

10. The turbine housing of claim 1, wherein the turbine outlet passage comprises a substantially asymmetrical passage.

11. A turbocharger for an internal combustion engine, the turbocharger comprising:
a turbine housing configured to receive an exhaust gas flow from an exhaust manifold of the internal combustion engine;
a turbine outlet passage integrated in the turbine housing, the turbine outlet being a substantially asymmetrical passage in fluid communication with a turbine volute, the turbine outlet passage configured to be coupled to a catalytic converter to direct the exhaust gas flow from the turbine volute thereto; and
a compressor inlet passage integrated with a compressor housing, the compressor inlet passage configured to direct an air flow to a compressor wheel rotatably disposed within a compressor volute, wherein the compressor inlet passage includes an offset portion to, thereby cause a swirling air flow into the compressor volute.

12. The turbocharger of claim 11, wherein the compressor inlet passage comprises a common wall with the compressor volute.

13. The turbocharger of claim 11, wherein the offset portion of the compressor inlet passage creates the swirling air flow in a direction of the compressor wheel rotation.

14. The turbocharger of claim 11, wherein the turbine outlet passage comprises a cone shaped passage.

15. The turbocharger of claim 11, wherein an inner surface of the turbine outlet passage comprises a substantially arc shaped cross section.

16. The turbocharger of claim 11, wherein an opening of the turbine outlet is coupled to the catalytic converter via a coupling that comprises a weld or a band.

17. The turbocharger of claim 11, wherein the turbine outlet passage comprises a cone shaped passage configured to distribute the exhaust gas flow across a face of the substrate to cause a flow uniformity value of greater than about 0.9 at a selected operating condition.

18. A method for forced air induction of an internal combustion engine, the method comprising:
directing an exhaust gas flow from an exhaust manifold via a turbine inlet passage to a turbine volute that is configured to house a turbine wheel;
directing the exhaust gas flow from the turbine volute to a turbine outlet passage, wherein the turbine outlet passage comprises a cone shaped substantially asymmetrical passage;
directing the exhaust gas flow from the turbine outlet passage to a catalytic converter coupled to the turbine outlet passage; and
directing an air flow into a compressor inlet passage integrated in a compressor housing, wherein the compressor inlet passage includes an offset portion to induce a swirling air flow into a compressor volute.

19. The method of claim 18, wherein directing the exhaust gas flow from the turbine outlet passage comprises distributing the exhaust gas flow across a face of a catalytic converter substrate to cause a flow uniformity value of greater than about 0.9 at a selected operating condition.

20. The method of claim 18, wherein directing the air flow into the compressor inlet passage integrated in the compressor housing comprises directing the air flow into the compressor inlet passage that shares a wall with the compressor volute.
